(19) United States
(12) Patent Application Publication
(10) Pub. No.: US 2026/0055792 A1
(43) Pub. Date: Feb. 26, 2026

(54) AFFIRMATIVELY RETAINED SELF-SEALING BEARING CAP

(71) Applicant: VALCRUM, LLC, CYPRESS, TX (US)

(72) Inventor: Mario T. Robles, JR., Cypress, TX (US)

(73) Assignee: VALCRUM, LLC, CYPRESS, TX (US)

(21) Appl. No.: 19/304,748

(22) Filed: Aug. 20, 2025

Related U.S. Application Data
(60) Provisional application No. 63/685,304, filed on Aug. 21, 2024.

(51) Int. Cl. F16C 35/02; F16C 17/02

(52) U.S. Cl. CPC F16C 35/02; F16C 17/02; F16C 2326/02

(57) ABSTRACT

A hub system having a lubrication chamber including an outer bearing shoulder and an inner bearing shoulder. The hub has an outer end surface and an inner end surface. The hub includes a counterbore that extends inwardly from the outer end surface. The counterbore has a retention groove located therein between the outer end surface and the outer bearing shoulder. A retainer is held within the retention groove. The retainer has a base with an annular perimeter and has a plurality of fingers that extend inwardly of the annular perimeter. A bearing cap having an outer diameter is insertable into the counterbore. A release ring is held adjacent to the retainer. The release ring is shiftable from a first position adjacent to the fingers and a second position where the fingers are displaced from their location when the release ring is in its first position.

### CROSS REFERENCE TO RELATED APPLICATIONS

This application claims priority of U.S. Provisional application 63/685,304, filed Aug. 21, 2024, which application is hereby incorporated in its entirety by reference.

### BACKGROUND OF THE INVENTION

Axle assemblies of trailers have wheel hubs with lubricant chambers that surround bearings within those chambers. The lubricant can be either grease or oil. Having proper lubrication is critical to bearing life and proper function. The chambers need not be completely filled with lubricant. This is particularly the case in oil bath type bearings, in which the chamber is partially filled with lubricant and oil forms a bath through which the bearings rotate. In either oil or grease lubricated bearings, keeping the lubricant held within the chamber surrounding the bearings and debris out is critical to maintaining the bearings. Keeping the lubricant held within the chamber surrounding the bearings is critically important for oil bath type bearings because the oil may flow completely out of the chamber if not contained with a reliable bearing cap.

Traditionally, bearing caps rely on a machined counterbore on the hub into which the bearings are placed. The bearing cap is then pressed into the counterbore with a matching outer diameter. The metal-on-metal press fit is the only seal that prevents water or other contaminants from entering the hub and the bearings. While it may be possible to have a perfect fit at the connection of the bearing cap outer diameter and the corresponding counterbore in the hub, there is certainly ample opportunity for an imperfection in either part to provide a leak path that is detrimental to the bearings.

Retention of traditional press fit bearing caps is problematic. In this type of bearing cap nothing but friction of the press fit metal-on-metal connection holds the bearing cap in place. That metal-on-metal connection may work for a period of time, but the time that such a metal-on-metal connection remains secure may be significantly reduced by any misalignment during installation. The user of press fit metal bearing caps is relying on nearly perfect installation alignment to provide retention that is not very secure even under ideal conditions. Therefore, there is an unmet need for a bearing cap that has better sealing and more secure retention.

### SUMMARY OF THE INVENTION

A hub system with a hub having a lubrication chamber. The hub includes an outer bearing shoulder and an inner bearing shoulder in the lubrication chamber. The hub has an outer end surface and an inner end surface. The hub includes a counterbore that extends inwardly from the outer end surface. The counterbore has a retention groove located therein between the outer end surface and the outer bearing shoulder.

A retainer is held within the retention groove. The retainer has a base with an annular perimeter and has a plurality of fingers that extend inwardly of the annular perimeter. A bearing cap having an outer diameter is insertable into the counterbore. A release ring is held adjacent to the retainer. The release ring is shiftable from a first position adjacent to the fingers and a second position where the fingers are displaced from their location when the release ring is in its first position.

### BRIEF DESCRIPTION OF THE DRAWINGS

FIG. 1 is a perspective view of the hub with fully assembled components;

FIG. 2 is an end view of the hub shown in FIG. 1 without the bearing cap installed;

FIG. 3 is a sectional view taken about the line 3-3 in FIG. 2;

FIG. 4 is a magnified view of area 4 of the outer end of the hub shown in FIG. 3;

FIG. 5 is a perspective view of the hub shown in FIGS. 1-4 and bearing cap just before being installed into the hub;

FIG. 6 is a perspective view of the hub shown in FIGS. 1-5 and bearing cap being installed into the hub;

FIG. 7 is a sectional view taken about the line 7-7 in FIG. 6;

FIG. 8 is a magnified view of area 8 in FIG. 7 with the release ring disengaged and the fingers of the retainer engaged;

FIG. 9 is a sectional view like that shown in FIG. 7 just before the bearing cap is installed into the hub;

FIG. 10 is a sectional view like that shown in FIG. 8 with the release ring engaged and the fingers of the retainer disengaged;

FIG. 11 is a perspective view of the bearing cap;

FIG. 12 is a sectional view of the bearing cap shown in FIG. 11;

FIG. 13 is a perspective view of the release ring;

FIG. 14 is a side view of the release ring;

FIG. 15 is a perspective view of the retainer; and

FIG. 16 is a side view of the retainer shown in FIG. 15.

### DETAILED DESCRIPTION OF INVENTION

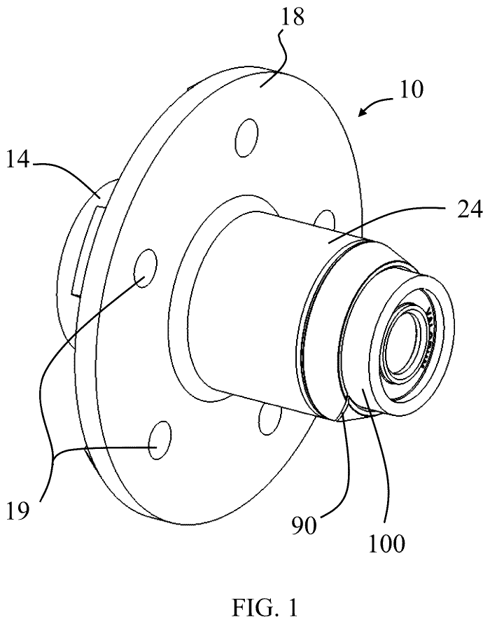

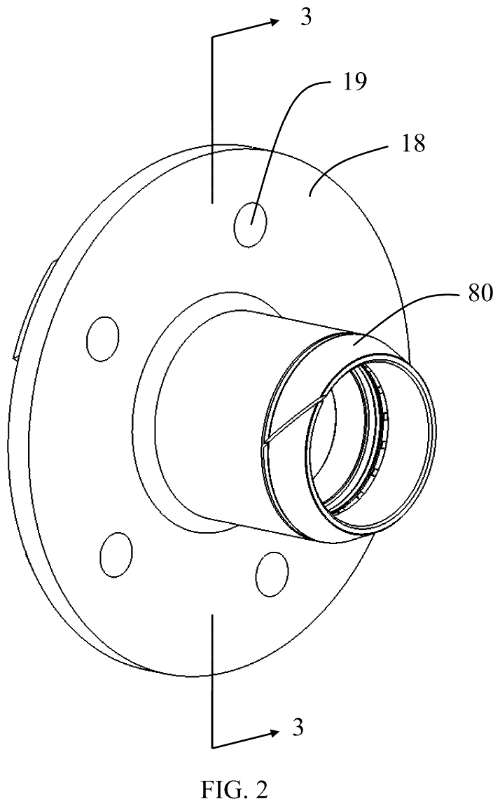

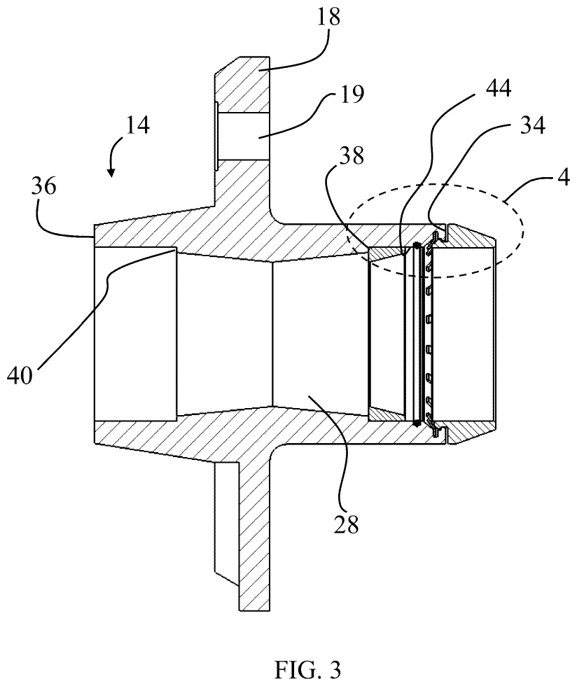

FIG. 1 shows a hub system 10 according to the present invention. The hub 14 has a flange 18 that is for receiving bolts (not shown) in bolt holes 19 that are spaced around the flange 18. The flange 18 surrounds the body 24 of the hub 14. The body 24 includes a lubricant chamber 28 that extends through the hub 14. The lubricant chamber 28 is a shape of revolution with various features that are located between an outer end surface 34 and an inner end surface 36. An outer end surface 34 and an inner end surface 36 define the ends of the lubricant chamber 28. The lubricant chamber 28 is for surrounding a spindle (not shown) about which the hub 14 rotates. The hub 14 is supported by angle contact bearings, as is well known in the art. An outer set of angle contact bearings is pressed against the outer bearing shoulder 38 and an inner set of angle contact bearings is pressed against the inner bearing shoulder 40. The sets of angle contact bearings being pressed against the bearing shoulders 38, 40 maintain the hub 14 in a concentrically rotatable position surrounding the spindle that passes through the lubrication chamber 28. The lubricant chamber 28 has a counterbore 44 adjacent to the outer bearing shoulder 38. Counterbore 44 extends between the outer bearing shoulder 38 and the outer end surface 34. A nut (not shown) is tightened near the outer end surface of the body 24 of the hub 14 and that provides a preload on the bearings to press them against their respective bearing shoulders 38, 40.

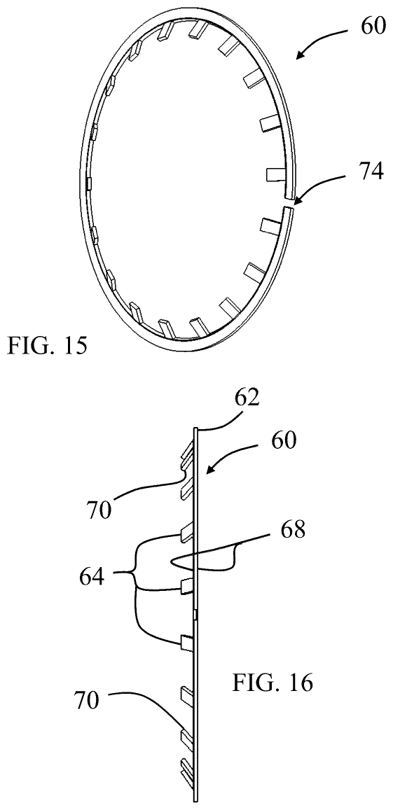

The hub 14 has a retention groove 46 that is spaced inwardly of the outer end surface 34. The retention groove 46 has an outer surface 48, a bottom surface 50, and an inner surface 52 that is adjacent to an inclined surface 54 and is angled inwardly with respect to the counterbore 44 in which the retention groove 46 is located. The counterbore 44 also includes an O-ring groove 56 that is located inwardly of the retention groove 46. The O-ring groove 56 is located between the retention groove 46 and the outer bearing shoulder 38. The retention groove 46 receives a retainer 60 that is shown alone in FIGS. 15 and 16. The retainer 60 has an annular base 62 with fingers 64 with respect to the base 62. The base 62 has opposite planar surfaces 68 that define the thickness of the base 62. The fingers 64 are of the same thickness as the base 62 and include biting edges 70 on each of the fingers 64. The base 62 is broken with a gap 74 that defines ends that are adjacent to each other. The base 62 may be manipulated by moving the ends of the base 62 so that the base 62 can be inserted into the retention groove 46. Once the base 62 is inserted into the retention groove 46, it remains captured therein and the springiness of the base 62 tends to bias the outer perimeter of the base 62 against the bottom surface 50 of the retention groove 46. An O-ring 78 is held within the O-ring groove 56.

A release ring 80 is inserted into the counterbore 44. The release ring 80 has an inclined surface 82 and a stop flange 86 that is opposite the inclined surface 82. The release ring 80 is inserted into the counterbore 44 so that the inclined surface 82 faces the counterbore 44. The release ring 80 has a catch surface 88 that faces the stop flange 86. The catch surface 88 is captured within the retention groove 46, as shown in FIG. 5, and retains the release ring 80 in the counterbore 44. The release ring 80 is a split ring with a gap 90 and is like the retainer 60.

Likewise, the release ring 80 is biased outward within the retention groove 46 of the counterbore 44. This ensures the catch surface 88 engages the retention groove 46 so the release ring 80 does not fall out of the counterbore 44.

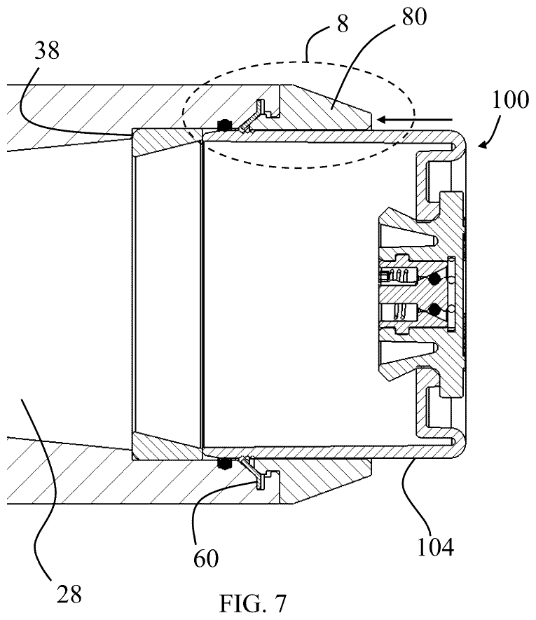

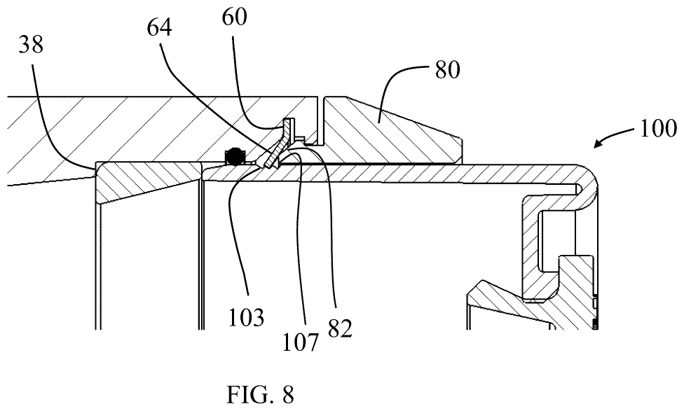

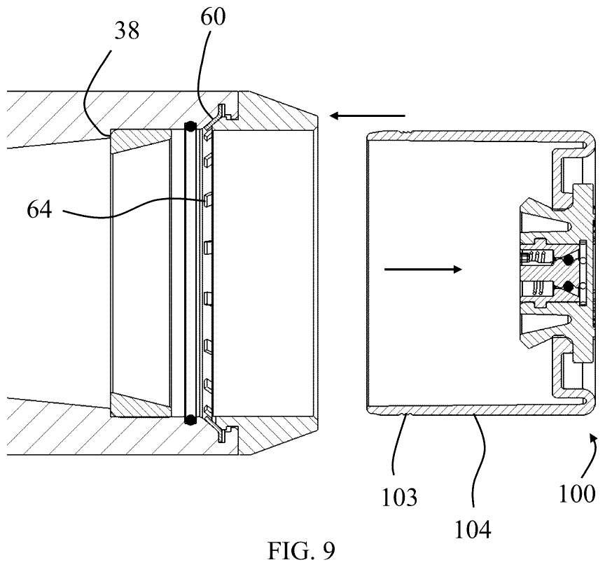

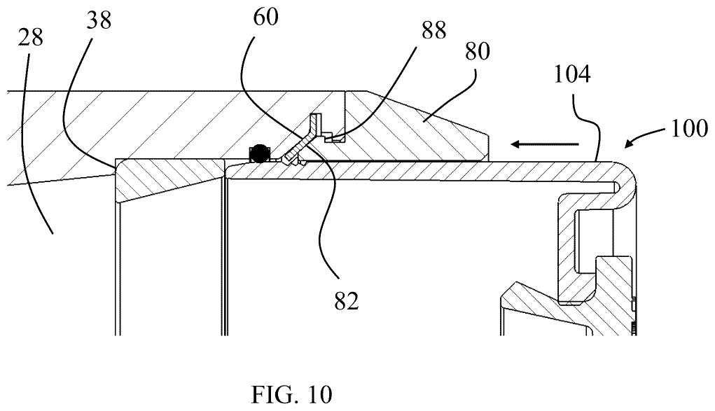

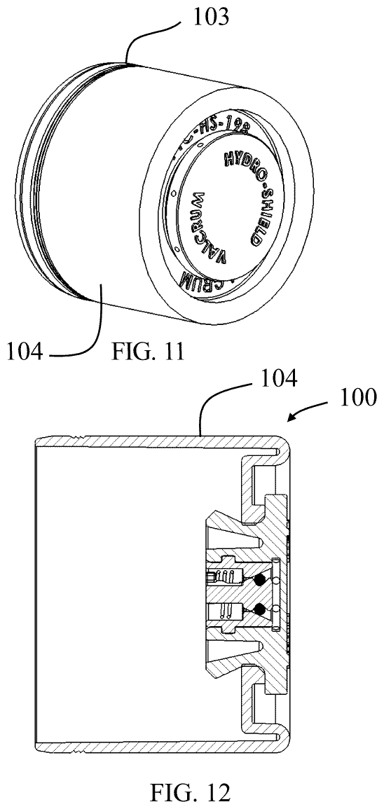

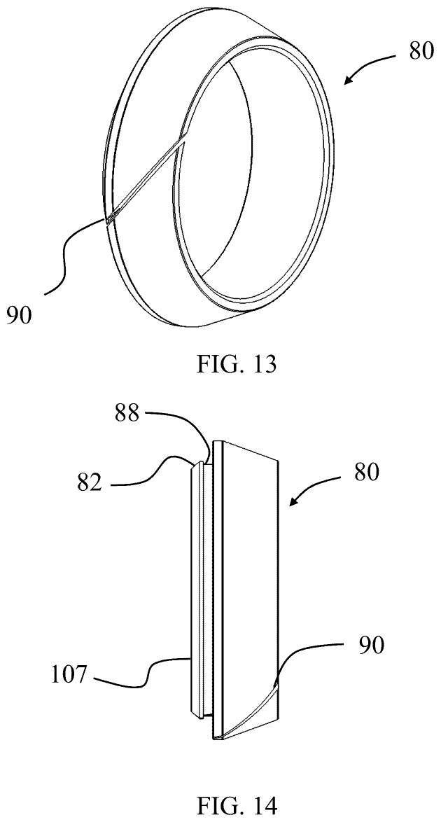

A bearing cap 100 having an outer diameter 104 is adapted for having the outer diameter 104 inserted into the counterbore 44. The bearing cap 100 is typically made of metal, but could also be made of a durable plastic. The bearing cap 100 is installed by pressing it into the counterbore 44 by any typical means that has been traditionally used to install bearing caps 100. The bearing cap 100 can be any one of many types of traditional parts as long as the bearing cap 100 has an outer diameter 104 that will mate with the counterbore 44. Upon pressing the bearing cap 100 into the counterbore 44, the fingers 64 contact the outer diameter 104 of the bearing cap 100 in a biased fashion because the diameter of the biting edges 70 of the fingers 64 are at a smaller diameter than the outer diameter 104 of the bearing cap 100. The biting edges 70 are crisp corners that allow the bearing cap 100 to move inwardly toward the outer bearing shoulder 38, but the fingers 64 prevent the bearing cap 100 from moving outwardly in the opposite direction. As the outer diameter 104 of the bearing cap 100 moves through the fingers 64, the fingers 64 are displaced outwardly. The outer diameter 104 of the bearing cap 100 may be smooth over its entire surface and the biting edges 70 of the fingers 64 will work to prevent the bearing cap 100 from being dislodged from the counterbore 44. The bearing cap 100 has grooves 103 that are located to engage the biting edges 70 of the fingers 64. FIG. 7 shows the fingers 64 in retaining engagement with the grooves 103 in the outer diameter 104 of the bearing cap 100. FIG. 8 is a magnified view further showing the detail of how the fingers 64 engage the grooves 103.

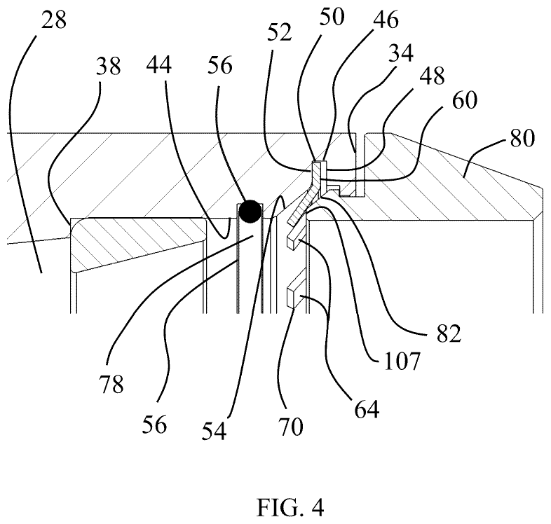

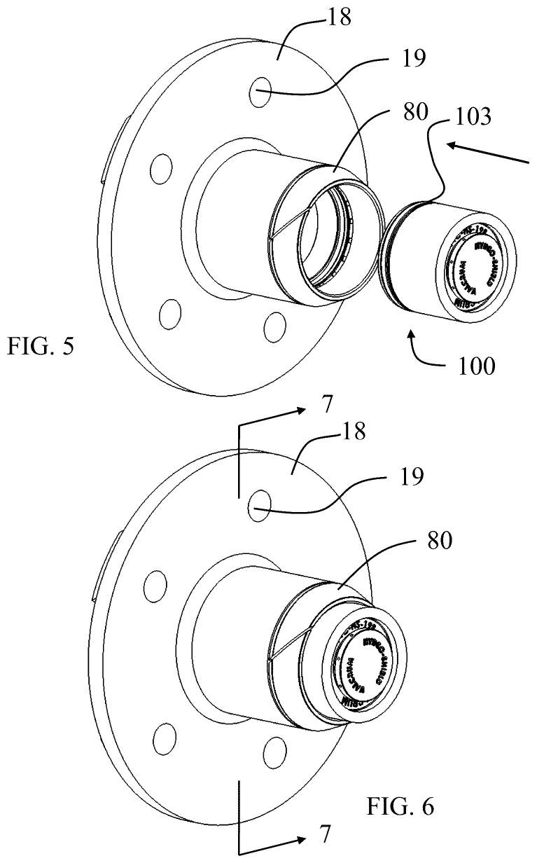

The inclined surface 54 of the retention groove 46 allows the fingers 64 to flex outwardly as they are displaced outwardly by the inclined surface 82 of the release ring 80 when being pressed toward the fingers 64 to urge the fingers 64 away from the outer diameter 104 of the bearing cap 100. It should be noted that the inclined surface 82 does not need to be an incline, but may be a flat surface that contacts the fingers 64 to flex them radially outward and away from the outer diameter 104 of the bearing cap 100. As seen in FIG. 4, the terminal end 107 of the release ring 80 may contact the fingers without an inclined surface 82. All that is required is that a portion of the release ring 80 contacts the fingers 64 at a location spaced from the base 62 so that pushing the release ring 80 toward the fingers 64 urges them away from the outer diameter 104. The biased contact of the fingers 64 against the outer diameter 104 provides a self-energizing biting action that restrains the bearing cap 100 from being removed from the counterbore 44 of the hub 14. The self-energizing of the fingers 64, with respect to the outer diameter 104 of the bearing cap 100, refers to the fact that if the bearing cap 100 is pulled outwardly, the biting edges 70 of the fingers 64 will be encouraged to dig into the outer diameter 104 and provide an even tighter grip on the outer diameter 104 than just the bias of the fingers 64 alone would provide. The grooves 103 in the outer diameter 104 enhance the self-energizing biting action of the fingers 64.

The length of the outer diameter 104 on the bearing cap 100 is long enough that it will seal upon an O-ring 78 that is held in the O-ring groove 56. The O-ring 78 is located nearer the outer bearing shoulder 38 than the retention groove 46. Although this is the configuration shown, it is possible to have the retention groove 46 nearer the outer bearing shoulder 38 than the O-ring groove 56 so that the outer diameter 104 contacts the O-ring 78 before the retainer 60. The outer diameter 104 has a tight seal against the O-ring 78 and this prevents lubricant from leaving the lubricant chamber 28 though the O-ring 78 and also prevents contaminants, such as water, from entering the lubricant chamber 28 through the O-ring 78 from outside the bearing cap 100. The fact that sealing is accomplished upon the O-ring 78 sealing against the outer diameter 104 of the bearing cap 100 means that the outer diameter 104 may have more clearance within the counterbore 44 than would be done with traditional press fit bearing caps. The outer diameter 104 of the bearing cap 100 is slightly smaller than the diameter of the counterbore 44. The clearance fit between the outer diameter 104 and the counterbore 44 makes installing the bearing cap 100 much easier than the traditional method of hammering on bearing caps, which can lead to damaging a traditional bearing cap 100 from the outset during its installation. It is contemplated that a line to line fit can be used between the bearing cap 100 and the counterbore 44, which means the outer diameter 104 and the diameter of the counterbore 44 are the same. The system of the present invention allows for the outer diameter 104 not having an interference fit with the counterbore 44 as has been done traditionally. The aforementioned features allow for an outer diameter 104 that may of an equal to or smaller diameter than that of the counterbore 44.

The release ring 80 is shiftable from a first position to a second position. The first position, shown in FIGS. 4 and 8, corresponds to the inclined surface 82 being adjacent to the fingers 64 and the fingers 64 being biased against the outer diameter 104 of the bearing cap 100 without a reduction of the biasing force the fingers 64 produce against the outer diameter 104.

The biasing of the fingers 64 occurs on the outer diameter 104 where the grooves 103 are located, but as stated above that is not absolutely necessary in the case that the outer diameter 104 is smooth. The second position of the release ring 80 corresponds to where the release ring 80 is shifted inwardly to flex the fingers 64 though contact with the inclined surface 82. This second position is shown in FIG. 7. The second position of the release ring 80 shifts the fingers 64 radially outwardly from their location when the release ring 80 is in its first position. The second position of the release ring 80 is characterized by the catch surface 88 being spaced away from the outer surface 48 of retention groove 46. When the inclined surface 82 has pushed the fingers 64 outwardly enough so that biting edges 70 of the fingers 64 are displaced out of contact with the outer diameter 104 of the bearing cap 100, the bearing cap 100 may be removed from the counterbore 44 of the hub 14.

The invention is not limited to the details provided above but may be modified within the scope of the following claims.

What is claimed is:

1. A hub system comprising:
a hub having a lubrication chamber including an outer bearing shoulder and an inner bearing shoulder, an outer end surface and an inner end surface, a counterbore extending inwardly from said outer end surface, an O-ring groove within said counterbore and spaced from said outer bearing shoulder and located between said outer bearing shoulder and said outer end surface, a retention groove located in said counterbore between said outer end surface and said outer bearing shoulder, said retention groove being spaced from said O-ring groove;
an O-ring located in said O-ring groove;
a retainer having a base with an annular perimeter having a plurality of fingers extending inwardly of said annular perimeter, said base being retained within said retention groove, said fingers being angled with respect to said base;
a bearing cap having an outer diameter insertable into said counterbore; and
a release ring being held adjacent to said retainer and said release ring having an inclined surface, said inclined surface of said release ring for contacting said fingers of said retainer, said release ring being shiftable from a first position adjacent to said fingers and a second position wherein said fingers are displaced from their location when said release ring is in said first position.

2. The hub system of claim 1, wherein said outer diameter of said bearing cap is equal to or smaller than said counterbore.

3. The hub system of claim 1, wherein said outer diameter of said bearing cap includes a groove for mating with said fingers when said bearing cap is located in said counterbore.

4. A hub system comprising:
a hub having a lubrication chamber including an outer bearing shoulder and an inner bearing shoulder, an outer end surface and an inner end surface, a counterbore extending inwardly from said outer end surface, a retention groove located in said counterbore between said outer end surface and said outer bearing shoulder;
a retainer having a base with an annular perimeter having a plurality of fingers extending inwardly of said annular perimeter, said base being retained within said retention groove, said fingers being angled with respect to said base and extending into said counterbore;
a bearing cap having an outer diameter insertable into said counterbore; and
a release ring being held adjacent to said retainer, said release ring being shiftable from a first position adjacent to said fingers wherein said fingers contact said outer diameter of said bearing cap within said counterbore with said release ring in said first position and a second position wherein a portion of said release ring contacts said fingers and displaces said fingers from their location when said release ring is in said first position.

5. The hub system of claim 4, wherein said counterbore includes an O-ring groove having an O-ring therein, said O-ring groove being spaced from said retention groove.

6. The hub system of claim 5, wherein said outer diameter of said bearing cap is equal to or smaller than said counterbore.

7. The hub system of claim 5, wherein said outer diameter of said bearing cap includes a groove for mating with said fingers when said bearing cap is located in said counterbore.

8. A hub system comprising:
a hub having a lubrication chamber including an outer bearing shoulder and an inner bearing shoulder, an outer end surface and an inner end surface, a counterbore extending inwardly from said outer end surface, a retention groove located in said counterbore between said outer end surface and said outer bearing shoulder;
a retainer having a base with an annular perimeter having a plurality of fingers extending inwardly of said annular perimeter, said base being retained within said retention groove, said fingers being angled with respect to said base and extending into said counterbore;
a bearing cap having an outer diameter insertable into said counterbore; and
a release ring being held adjacent to said retainer, said release ring being shiftable from a first position adjacent to said fingers wherein said fingers are in biased contact with said outer diameter of said bearing cap within said counterbore with said release ring in said first position and a second position wherein a portion of said release ring contacts said fingers and displaces said fingers from biased contact with said outer diameter of said bearing cap.

9. The hub system of claim 8, wherein said counterbore includes an O-ring groove having an O-ring therein, said O-ring groove being spaced from said retention groove.

10. The hub system of claim 9, wherein said outer diameter of said bearing cap is equal to or smaller than said counterbore.

11. The hub system of claim 9, wherein said outer diameter of said bearing cap includes a groove for mating with said fingers when said bearing cap is located in said counterbore.
